(19) United States
(12) Patent Application Publication
(10) Pub. No.: US 2025/0096332 A1
(43) Pub. Date: Mar. 20, 2025

(54) SEPARATOR FOR LITHIUM SECONDARY BATTERY AND LITHIUM SECONDARY BATTERY INCLUDING SAME

(71) Applicant: SAMSUNG SDI CO., LTD., Gyeonggi-do (KR)

(72) Inventors: Dongwan SEO, Gyeonggi-do (KR); Jinyoung KIM, Gyeonggi-do (KR); Hyeonseon CHOI, Gyeonggi-do (KR)

(73) Assignee: SAMSUNG SDI CO., LTD., Gyeonggi-do (KR)

(21) Appl. No.: 18/729,254

(22) PCT Filed: Feb. 20, 2023
(86) PCT No.: PCT/KR2023/002419

§ 371 Date: Jul. 16, 2024

(30) Foreign Application Priority Data
Apr. 15, 2022 (KR) 10-2022-0047157

(51) Int. Cl. H01M 10/42; H01M 10/052; H01M 50/417; H01M 50/42; H01M 50/426; H01M 50/434; H01M 50/446; H01M 50/449; H01M 50/489

(52) U.S. Cl. CPC H01M 10/4235; H01M 10/052; H01M 50/417; H01M 50/42; H01M 50/426; H01M 50/434; H01M 50/446; H01M 50/449; H01M 50/489

(57) ABSTRACT

Examples of the disclosure include a separator for a lithium secondary battery, and a lithium secondary battery including the separator. The separator for a lithium secondary battery includes a porous substrate; and a coating layer which is located on at least one side of the porous substrate and that includes polyethylene particles and ceramics, wherein the ceramics have an aspect ratio of 1.5-3.0.

### TECHNICAL FIELD

A separator for a lithium secondary battery and a lithium secondary battery including the same are disclosed.

### BACKGROUND ART

Lithium secondary batteries have a high discharge voltage and high energy density, and are attracting attention as a power source for various electronic devices.

A lithium secondary battery is arranged so that the positive and negative electrodes may face each other, has a structure filled with an electrolyte solution, and a separator is located between the positive and negative electrodes to prevent short circuit. The separator may be a porous material that may transfer ions or electrolytes.

If a battery is exposed to a high temperature environment due to abnormal behavior, a separator may mechanically shrink or be damaged due to melting characteristics at a low temperature. Herein, the positive and negative electrodes contact each other and may cause an explosion of the battery. In order to solve the problems, technology is needed to suppress shrinkage of the separator and ensure the safety of the battery.

### DISCLOSURE

### Technical Problem

An embodiment is to provide a separator for a lithium secondary battery with excellent safety.

Another embodiment provides a lithium secondary battery including the separator.

### Technical Solution

According to an embodiment, a separator for a lithium secondary battery includes a porous substrate; and a coating layer located on at least one surface of the porous substrate and including polyethylene particles and ceramics, wherein the ceramics have an aspect ratio of 1.5 to 3.0.

The ceramics may be cubic.

The polyethylene particles may have a melting temperature (Tm) of 100° C. to 120° C.

Additionally, a weight average molecular weight (Mw) of the polyethylene particles may be 1000 g/mol to 5000 g/mol.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The separator may further include an adhesive layer formed on one surface of the coating layer.

The adhesive layer may include a binder and a filler.

According to another embodiment, a lithium secondary battery includes a negative electrode including a negative electrode active material; a positive electrode including a positive electrode active material; a separator between the negative electrode and the positive electrode; and a non-aqueous electrolyte.

Details of other embodiments are included in the detailed description below.

### Advantageous Effects

A separator for a lithium secondary battery according to an embodiment may exhibit excellent safety.

### DESCRIPTION OF THE DRAWINGS

FIG. 1 is a view briefly showing a lithium secondary battery according to an embodiment.

FIG. 2 is a schematic view of a separator for a lithium secondary battery according to an embodiment.

FIG. 3 is an SEM image showing the state of the separator manufactured according to Example 1 before increasing the temperature.

FIG. 4 is an SEM image showing the state of the separator manufactured according to Example 1 after increasing the temperature.

### MODE FOR INVENTION

Hereinafter, embodiments of the present invention are described in detail. However, these embodiments are exemplary, the present invention is not limited thereto and the present invention is defined by the scope of claims. The terminology used herein is used to describe embodiments only, and is not intended to limit the present disclosure. The singular expression includes the plural expression unless the context clearly dictates otherwise.

“Combination thereof” means a mixture, laminate, composite, copolymer, alloy, blend, reaction product, and the like of the constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

“Thickness” may be measured, for example, with a micrometer or through a photograph taken with an optical microscope such as a scanning electron microscope.

The average size may refer to an average particle diameter (D50), and in the present specification, when a definition is not otherwise provided, an average particle diameter (D50) indicates a particle where a cumulative volume is 50 volume % in a particle distribution.

The average particle size (D50) may be measured by a method well known to those skilled in the art, for example, by a particle size analyzer, a transmission electron microscope image, or a scanning electron microscope image. Alternatively, a dynamic light-scattering measurement device is used to perform a data analysis, and the number of particles is counted for each particle size range. From this, the average particle diameter (D50) value may be easily obtained through a calculation.

A separator according to an embodiment includes a porous substrate and a coating layer located on at least one surface of the porous substrate and including polyethylene particles and ceramics having an aspect ratio of 1.5 to 3.0.

The polyethylene particles may have a melting temperature (Tm) of 100° C. to 120° C.

The polyethylene particles do not melt during normal charging and discharging within the battery, but if a high temperature phenomenon occurs within the battery, they melt before the porous substrate above the melting temperature and block the pores within the porous substrate to block the movement of ions, induce a quick shutdown function, and ensure the safety of the secondary battery. To explain this in more detail, the melting temperature of polyethylene particles is 100° C. to 120° C., which is approximately 30° C. lower than the melting temperature of the porous substrate, and thus, if a high temperature phenomenon occurs in the battery, they may melt before the porous substrate.

Accordingly, if the melting temperature of the polyethylene particles is lower than 100° C., melting occurs at too low a temperature and shutdown may occur before the temperature required for operation, and if it is higher than 120° C., melting does not occur well before the porous substrate, there may be a problem as the shutdown effect is somewhat reduced.

In an embodiment, the polyethylene particles may be in a wax form. At this time, the wax form, that is, polyethylene wax, means that the molecular weight is larger than that of an oligomer and smaller than that of a polymer, and for example, the weight average molecular weight (Mw) may be 1000 g/mol to 5000 g/mol, 1000 g/mol to 3000 g/mol, or 1500 g/mol to 3000 g/mol.

If the weight average molecular weight of the polyethylene particles is within this range, there may be an advantage of shutdown at low temperatures.

In an embodiment, if the melting temperature of the polyethylene particles is satisfied, or if the melting temperature and weight average molecular weight are satisfied, it is sufficient to obtain the desired shutdown effect, and thus there is no need to limit the shape or size.

An aspect ratio of the ceramic may be 1.5 to 3.0. The aspect ratio refers to a length of the major axis of the ceramic relative to the minor axis. If the aspect ratio is within the above range, the coating density of the coating layer increases, a dense coating layer is formed, and a good shutdown effect may be obtained. If the aspect ratio of the ceramic is less than 1.5, the specific surface area increases and the moisture in the coating layer increases, which may cause a problem of cell performance deterioration due to side reactions within the cell, and if it exceeds 3.0, there may be a problem that the coating density decreases and the shutdown effect decreases.

In an embodiment, the aspect ratio may be measured by a method well known to those skilled in the art, for example, using a transmission electron microscope photograph or a scanning electron microscope photograph.

Additionally, the ceramic may be cubic. If the ceramic is cubic, breathability characteristics may be improved. This means that the time for air to pass through the separator is shortened, and thus the air permeability value is reduced. In this way, a low air permeability value means that lithium ions may easily pass through the separator during charging and discharging. If the ceramic is plate-shaped rather than cubic, the air permeability characteristics may be disadvantageous due to the stacked form of the plates if stacked, and if the ceramic is spherical or unspecific shaped, gaps between ceramics may be wide and the coating density may be lowered, resulting in lower air permeability characteristics, that is, lower air permeability value.

An average size (D50) of the ceramic may be 0.5 μm to 3.0 μm, 0.5 μm to 2.0 μm, 0.5 μm to 1.0 μm, 550 nm to 750 nm, 600 nm to 750 nm, or 600 nm to 700 nm, but is limited thereto.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

In the coating layer, the mixing ratio of the polyethylene particles and the ceramics may be 10:90 to 90:10, 20:80 to 80:20, or 30:70 to 70:30. If the mixing ratio of polyethylene particles and ceramics is within the above range, it is appropriate because shutdown characteristics may be further strengthened and heat resistance may be further strengthened without deteriorating air permeability characteristics.

The coating layer may further include a binder. The binder may be a dispersed binder, a curable binder, or an aqueous binder.

The dispersion binder may be sodium polyacrylate, ammonium polyacrylate, potassium polyacrylate, or a combination thereof. An amount of the dispersion binder may be adjusted appropriately, and for example, the amount of the dispersion binder may be 0.5 wt % to 2 wt % or 1 wt % to 2 wt % based on a weight of the ceramics, but there is no need to be limited thereto.

The aqueous binder may further include, for example, a styrene-butadiene rubber, an acrylated styrene-butadiene rubber, polyvinyl alcohol, a copolymer of propylene and a C2 to C8 olefin, poly acrylamide, a copolymer of (meth)acrylic acid and (meth)acrylic acid alkyl ester, or a combination thereof.

The curable binder may be polyglycidyl ether, isocyanate, epoxy, or a combination thereof.

In another embodiment, the curable binder may be at least one of an acrylic copolymer and a fluorine-based binder.

The acrylic copolymer may be in the form of particles, and the fluorine-based binder may also be in the form of particles. In an embodiment, (meth)acrylic may mean acrylic or methacrylic.

The acrylic copolymer may be a (meth)acrylic copolymer, for example, a (meth)acrylic copolymer having a core-shell structure. Specifically, it may be a (meth)acrylic polymer including a structural unit derived from (meth)acrylic acid or (meth)acrylate and a structural unit derived from a monomer including a polymerizable unsaturated group.

More specifically, the core of the (meth)acrylic adhesive binder may include a structural unit derived from (meth)acrylic acid or (meth)acrylate, and the shell of the (meth)acrylic adhesive binder may include a structural unit derived from a monomer including a polymerizable unsaturated group.

The monomer including the polymerizable unsaturated group included in the shell of the (meth)acrylic adhesive binder may be at least one selected from a styrene-based monomer, an acid-derived monomer, and a combination thereof.

Specifically, the styrene-based monomer may include at least one aromatic vinyl monomer represented by Chemical Formula 10.

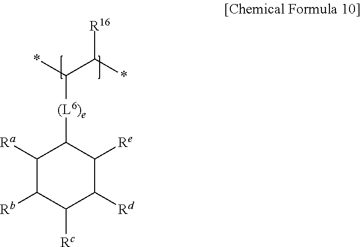

In Chemical Formula 10,
R¹⁶ is hydrogen or a C1 to C6 alkyl group,
R^{a} to Re are independently hydrogen or a C1 to C6 alkyl group,
L⁶ is a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
e is one of the integers from 0 to 2, and
* is a linking point.

More specifically, the styrene-based monomer may be at least one selected from methyl styrene, bromo styrene, chloro styrene, and a combination thereof as well as styrene.

More specifically, the acid-derived monomer may include a substituent corresponding to —COOH and may be at least one selected from itaconic acid, (meth)acrylic acid, and a combination thereof.

For example, the acrylic copolymer may be an acrylic copolymer including a repeating unit derived from a (meth)acrylate-based monomer. In addition, the acrylic copolymer may further include repeating units derived from an acetate group-containing monomer in addition to repeating units derived from the (meth)acrylate-based monomer.

The usable acrylic copolymer including a repeating unit derived from the (meth)acrylate-based monomer and/or a repeating unit derived from the acetate group-including monomer are not particularly limited as long as they may form good adhesion at the pressing temperature between the positive electrode and negative electrode, but the acrylic copolymer may be for example a copolymer produced by polymerizing one or more (meth)acrylate-based monomers selected from butyl (meth)acrylate, propyl (meth)acrylate, ethyl (meth)acrylate, and methyl (meth)acrylate. Alternatively, the acrylic copolymer may be a copolymer produced by polymerizing one or more (meth)acrylate-based monomers selected from butyl (meth)acrylate, propyl (meth)acrylate, ethyl (meth)acrylate, and methyl (meth)acrylate, and one or more acetate group-containing monomers selected from vinyl acetate and allyl acetate.

The repeating unit derived from the acetate group-containing monomer may be the repeating unit of Chemical Formula 11.

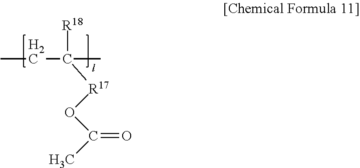

In Chemical Formula 11,
R¹⁷ is a single bond or linear or branched alkyl having C1 to C6, R¹⁸ is hydrogen or methyl, and I is each an integer between 1 and 100.

For example, the repeating unit derived from the acetate group-containing monomer may be a repeating unit derived from one or more acetate group-containing monomers selected from vinyl acetate and allyl acetate. The acrylic copolymer may be prepared by polymerizing (meth)acrylate-based monomers, or may be prepared by polymerizing (meth)acrylate-based monomers and other monomers other than (meth)acrylate-based monomers. For example, the other monomers may be an acetate group-containing monomer. In this case, the (meth)acrylate monomer and other monomers, specifically the acetate group-containing monomer, may be polymerized at a molar ratio of 3:7 to 7:3, specifically 4:6 to 6:4, and more specifically about 5:5. The acrylic copolymer may be prepared by a polymerization reaction, for example, of a butyl (meth)acrylate monomer, a methyl (meth)acrylate monomer, and a vinyl acetate and/or allyl acetate monomer at a molar ratio of 3 to 5:0.5 to 1.5:4 to 6, specifically at a molar ratio of 4:1:5.

The acrylic copolymers may be crosslinked or non-crosslinked. To prepare a crosslinked acrylic copolymer, a crosslinking agent may be further added during the polymerization step.

The glass transition temperature (Tg) of the acrylic copolymer may be 110° C. or less, and may be 20° C. to 110° C.

Within the above range, not only is electrode adhesion more excellent, but also better ionic conductivity may be exhibited.

A particle size of the acrylic copolymer may be 0.2 μm to 1.0 μm, specifically 0.2 μm to 0.7 μm, e.g., 0.3 μm to 0.7 μm or 0.4 μm to 0.7 μm. The particle size may be adjusted by controlling an addition amount of an initiator, an addition amount of an emulsifier, a reaction temperature, and a stirring speed.

The fluorine-based binder may specifically include a polyvinylidene fluoride (PVdF) homopolymer or a copolymer of vinylidene fluoride and another monomer.

Another_monomer that may be copolymerized with the vinylidene fluoride to form a copolymer may be one or more selected from chlorotrifluoroethylene, trifluoroethylene, hexafluoropropylene, ethylene tetrafluoride, and ethylene monomer. For example, the copolymer may be a polyvinylidene fluoride-hexafluoropropylene (PVdF-HFP) copolymer including a unit derived from a vinylidene fluoride monomer and a unit derived from a hexafluoropropylene monomer.

A weight average molecular weight of the fluorine-based binder may be 100,000 g/mol to 1,500,000 g/mol, or for example, 300,000 g/mol to 800,000 g/mol. If the weight average molecular weight of the fluorine-based binder satisfies the above range, the fluorine-based adhesive binder and a separator including the same may exhibit excellent adhesion, heat resistance, air permeability, and oxidation resistance.

The weight average molecular weight may be a polystyrene-reduced average molecular weight measured using gel permeation chromatography.

A glass transition temperature (Tg) of the fluorine-based binder may be −45° C. to −35° C., for example, −42° C. to −38° C., and a melting point may be 100° C. to 180° C., for example, 130° C. to 160° C. If the glass transition temperature and melting point of the fluorine-based binder satisfy the above ranges, the fluorine-based binder and the separator including the same may exhibit excellent adhesion, heat resistance, air permeability, and oxidation resistance. The glass transition temperature may be a value measured by differential scanning calorimetry.

A particle size of the fluorine-based binder may be 100 nm to 500 nm, or for example, 150 nm to 300 nm.

The particle diameter may be adjusted by controlling an addition amount of an initiator, an addition amount of an emulsifier, a reaction temperature, and a stirring speed.

In the coating layer, an amount of the aqueous binder may be 1.0 wt % to 10 wt %, 2 wt % to 8 wt %, 3 wt % to 8 wt %, or 3 wt % to 5 wt % based on 100 wt % of the coating layer. If an amount of the aqueous binder is within the above range, the adhesion between the coating layer and the porous substrate may be maintained more appropriately, and the resistance of the separator may be maintained at an appropriate level.

In the coating layer, an amount of the curable binder may be 0.25 wt % to 3 wt %, 0.25 wt % to 2 wt %, 0.5 wt %, 0.5 wt % to 1.5 wt %, or 0.5 wt % to 1 wt % based on 100 wt % of the coating layer. If the amount of the curable binder is within the above range, side reactions may not occur in the battery because there is no curable binder remaining after curing.

In an embodiment, a thickness of one surface of the coating layer may be 0.5 μm to 5 μm, for example, 1 μm to 5 μm, 1 μm to 4 μm, 1 μm to 3 μm, or 1 μm to 2 μm. The coating layer may be formed on only one surface or on both surfaces of the porous substrate. The thickness is a thickness of one surface, and thus if formed on both surfaces, it may be 1 μm to 10 μm, 2 μm to 10 μm, 2 μm to 8 μm, 2 μm to 6 μm, or 2 μm to 4 μm. If the thickness of the one surface of the coating layer is within the above range, the separator resistance and the binding force of the coating layer to the porous substrate may be maintained at an appropriate level.

The separator may further include an adhesive layer on one surface of the coating layer.

The adhesive layer may include a binder and filler.

In this specification, ‘(meth)acrylic’ means acrylic or methacrylic.

The binder may be (meth)acrylic acid, (meth)acrylate, (meth)acrylonitrile, (meth)acrylamidosulfonic acid, a (meth)acrylamidosulfonic acid salt, styrene, ethylhexyl acrylate, a combination thereof, or a copolymer thereof.

The filler may be polyvinylidene fluoride, a polyvinylidene fluoride-hexafluoropropylene copolymer, polytetrafluoroethylene, or a combination thereof.

A mixing ratio of the binder and filler in the adhesive layer may be 1:1 to 1:5 by weight, or 1:1 to 1:3 by weight. If the binder: filler mixing ratio is within the above range, superior adhesion may be achieved without increasing resistance.

A one surface thickness of the adhesive layer may be 0.1 μm to 4.0 μm, e.g., 0.1 μm to 3.0 μm, 0.1 μm to 2.0 μm, 0.1 μm to 1.0 μm, e.g., 0.3 μm to 1.0 μm, 0.4 μm to 1.0 μm, 0.4 μm to 0.9 μm, or 0.5 μm to 0.9 μm.

The porous substrate has a large number of pores and may be a substrate commonly used in batteries. The porous substrate may include any one selected from polyolefin such as polyethylene and polypropylene, polyester such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, a glass fiber, TEFLON (tetrafluoroethylene), and polytetrafluoroethylene, or a copolymer or mixture of two or more types thereof.

In an embodiment, the porous substrate may include polyolefin. The porous substrate including polyolefin may include, for example, a polyethylene single film, a polypropylene single film, a polyethylene/polypropylene double film, a polypropylene/polyethylene/polypropylene triple film, or a polyethylene/polypropylene/polyethylene triple film.

The porous substrate may have a thickness of 1 μm to 40 μm, e.g., 1 μm to 30 μm, 1 μm to 20 μm, 5 μm to 15 μm, or 5 μm to 10 μm.

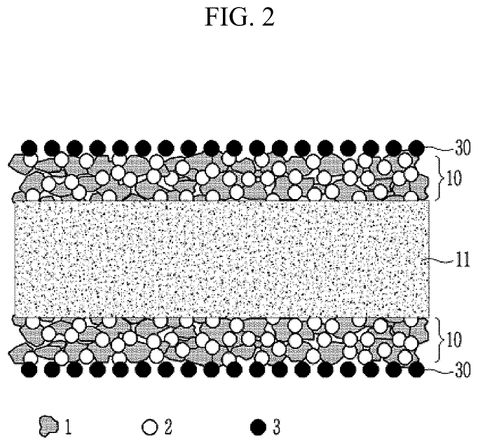

FIG. 2 shows a schematic structure of a separator according to an embodiment including a porous substrate 11, a coating layer 10 on both surfaces of the porous substrate 11, and an adhesive layer 30 on one surface of the coating layer. As shown in FIG. 2, the coating layer 10 includes ceramics 1 and polyethylene 2, and the adhesive layer 30 includes a binder.

A separator for a lithium secondary battery according to an embodiment may be manufactured by various known methods. For example, a separator for a lithium secondary battery is formed by coating a composition for forming a coating layer on one or both surfaces of a porous substrate and then drying it to form a coating layer, and coating a composition for forming an adhesive layer on one surface of the coating layer and then drying it to form an adhesive layer.

The composition for forming the coating layer may include ceramics, polyethylene particles, and a solvent, and may further include an aqueous binder. The solvent is not particularly limited as long as it may dissolve or disperse the ceramics and polyethylene particles and the aqueous binder. In an embodiment, the solvent may be an aqueous solvent including water, alcohol, or a combination thereof. The alcohol may be methyl alcohol, ethyl alcohol, propyl alcohol, or a combination thereof.

The composition for forming a coating layer may be prepared by adding ceramics and a dispersion binder to a solvent and mixing them to prepare a ceramic/binder liquid, and adding and mixing polyethylene, a curable binder, an aqueous binder, and a solvent to the ceramic/binder liquid. The dispersion binder may be utilized in a solid or liquid form, the aqueous binder may also be utilized in a solid or liquid form, and the curable binder may also be used in a solid or liquid form. If the dispersion binder, the curable binder, and the aqueous binder are utilized in a liquid form, the solvent may be an aqueous solvent including water, alcohol, or a combination thereof. The alcohol may be methyl alcohol, ethyl alcohol, propyl alcohol, or a combination thereof.

Additionally, the polyethylene particles may be utilized in solid or liquid form. If polyethylene particles are used in a liquid form, the solvent may be an aqueous solvent including water, alcohol, or a combination thereof. The alcohol may be methyl alcohol, ethyl alcohol, propyl alcohol, or a combination thereof.

If the dispersion binder is utilized in a liquid form, a concentration thereof may be 30 wt % to 50 wt %, and if the aqueous binder is utilized in a liquid form, a concentration may be 7.5 wt % to 9.5 wt %. Additionally, if the curable binder is utilized liquid form, a concentration thereof may be 15 wt % to 25 wt %. In addition, if polyethylene particles are utilized in liquid form, a concentration thereof may be 30 wt % to 50 wt %.

The dispersion binder may be the dispersion binder described above, the aqueous binder may be the aqueous binder described above, and the curable binder may be the curable binder described above.

In the composition for forming a coating layer, a mixing ratio of the materials utilized may be adjusted appropriately, and there is no need to specifically limit it.

Additionally, the mixing process may be performed through a milling process such as a bead mill or ball mill, but is not limited thereto.

The coating may be performed by, for example, spin coating, dip coating, bar coating, die coating, slit coating, roll coating, inkjet printing, etc., but is not limited thereto.

The drying may be performed by, for example, natural drying, drying with warm air, hot air or low humidity air, vacuum drying, irradiation with far-infrared rays, electron beams, etc., but is not limited thereto. The drying process may be performed at a temperature of, for example, 25° C. to 120° C.

The composition for forming an adhesive layer may include a binder, filler, and solvent. The solvent may be an aqueous solvent including water, alcohol, or a combination thereof. The alcohol may be methyl alcohol, ethyl alcohol, propyl alcohol, or a combination thereof. The binder and the filler are as described above.

Another embodiment provides a lithium secondary battery including a negative electrode, a positive electrode, a separator between the negative electrode and the positive electrode, and an electrolyte.

The separator is a separator according to an embodiment.

The negative electrode includes a current collector and a negative electrode active material layer formed on the current collector and including the negative electrode active material.

The negative electrode active material may be a material that reversibly intercalates/deintercalates lithium ions, a lithium metal, a lithium metal alloy, a material capable of doping/dedoping lithium, or a transition metal oxide.

Examples of the material that reversibly intercalates/deintercalates lithium ions include a carbon material, that is, a carbonaceous negative electrode active material commonly used in lithium secondary batteries. Representative examples of carbonaceous negative electrode active materials include crystalline carbon, amorphous carbon, or a combination thereof. Examples of the crystalline carbon may include graphite such as unspecified-shaped, plate-shaped, flake-shaped, spherical-shaped or fibrous-shaped natural graphite or artificial graphite, and examples of the amorphous carbon may include soft carbon or hard carbon, mesophase pitch carbonized product, calcined coke, etc.

The lithium metal alloy may include an alloy of lithium and a metal selected from Na, K, Rb, Cs, Fr, Be, Mg, Ca, Sr, Si, Sb, Pb, In, Zn, Ba, R^{a}, Ge, Al, and Sn.

The material capable of doping/dedoping lithium may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), a Si-carbon composite, Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), a Sn-carbon composite, and the like, and additionally, at least one of these may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

The titanium metal oxide may be lithium titanium oxide.

The negative electrode active material according to an embodiment may include a Si—C composite including a Si-based active material and a carbon-based active material.

The Si-based active material may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), or a combination thereof.

An average particle diameter of the Si-based active material may be 50 nm to 200 nm.

If the average particle diameter of the Si-based active material is within the above range, volume expansion that occurs during charging and discharging may be suppressed, and disconnection of the conductive path due to particle crushing during charging and discharging may be prevented.

The Si-based active material may be included in an amount of 1 wt % to 60 wt %, for example 3 wt % to 60 wt %, based on a total weight of the Si—C composite.

The negative electrode active material according to another embodiment may further include crystalline carbon along with the Si—C composite described above.

If the negative active material includes a Si—C composite and crystalline carbon, the Si—C composite and crystalline carbon may be included in the form of a mixture, in which case the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, may include natural graphite, artificial graphite, or a mixture thereof.

An average particle diameter of the crystalline carbon may be 5 μm to 30 μm.

In this specification, the average particle diameter may be the particle size (D50) at 50 volume % in the cumulative size-distribution curve. The average particle size (D50) may be measured by methods well known to those skilled in the art, for example, using a particle size analyzer, a transmission electron microscope photograph, or a scanning electron microscope. Alternatively, a dynamic light-scattering measurement device is used to perform a data analysis, and the number of particles is counted for each particle size range, and from this, the average particle diameter (D50) value may be easily obtained through a calculation.

The Si—C composite may further include a shell surrounding the surface of the Si—C composite, and the shell may include amorphous carbon. The thickness of the shell may be 5 nm to 100 nm.

The amorphous carbon may include soft carbon, hard carbon, mesophase pitch carbide, calcined coke, or mixtures thereof.

The amorphous carbon may be included in an amount of 1 to 50 parts by weight, for example, 5 to 50 parts by weight, or 10 to 50 parts by weight, based on 100 parts by weight of the carbonaceous active material.

The negative electrode active material layer includes a negative electrode active material and a binder, and may optionally further include a conductive material.

In the negative electrode active material layer, the negative electrode active material may be included in an amount of 95 wt % to 99 wt % based on the total weight of the negative electrode active material layer. An amount of the binder in the negative electrode active material layer may be 1 wt % to 5 wt % based on a total weight of the negative electrode active material layer. In addition, if a conductive material is further included, 90 wt % to 98 wt % of the negative electrode active material, 1 wt % to 5 wt % of the binder, and 1 wt % to 5 wt % of the conductive material may be utilized.

The binder serves to well attach the negative electrode active material particles to each other and also to well attach the negative electrode active material to the current collector. The binder may be a non-water-soluble binder, a water-soluble binder, or a combination thereof.

The non-water-soluble binder may be an ethylene propylene copolymer, polyacrylonitrile, polystyrene, polyvinyl chloride, carboxylated polyvinyl chloride, polyvinyl fluoride, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, an acrylonitrile-butadiene rubber, an acrylic rubber, butyl rubber, a fluoro rubber, an ethylene oxide-containing polymer, polyvinylpyrrolidone, polyepichlorohydrin, polyphosphazene, an ethylene propylenediene copolymer, polyvinylpyridine, chlorosulfonated polyethylene, latex, a polyester resin, an acrylic resin, phenolic resin, an epoxy resin, polyvinyl alcohol, or a combination thereof.

If a water-soluble binder is utilized as the negative electrode binder, a cellulose compound capable of imparting viscosity may be further included as a thickener. The cellulose compound may include one or more types of carboxymethyl cellulose, hydroxypropylmethyl cellulose, methyl cellulose, or alkali metal salts thereof. The alkali metal may be Na, K, or Li. An amount of the thickener used may be 0.1 to 3 parts by weight based on 100 parts by weight of the negative electrode active material.

The conductive material is used to impart conductivity to the electrode, and any material may be used as long as it does not cause chemical change in the battery to be configured and is an electron conductive material. Examples of the conductive material may be a carbon-based material such as natural graphite, artificial graphite, carbon black, acetylene black, ketjen black, denka black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The positive electrode includes a current collector and a positive electrode active material layer formed on the current collector and including a positive electrode active material. The positive electrode active material may include lithiated intercalation compounds that reversibly intercalate and deintercalate lithium ions, specifically one or more composite oxides of a metal selected from cobalt, manganese, nickel, and a combination thereof, and lithium. As a more specific example, a compound represented by any one of the following chemical formulas may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}CO_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α<2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂ (PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method (e.g., spray coating, dipping, etc.), but is not illustrated in more detail since it is well-known to those skilled in the related field.

In the positive electrode, an amount of the positive electrode active material may be 90 wt % to 98 wt % based on a total weight of the positive electrode active material layer.

In an embodiment, the positive electrode active material layer may further include a binder and a conductive material. At this time, each content of the binder and the conductive material may each be 1 wt % to 5 wt % based on a total weight of the positive electrode active material layer.

The binder serves to well attach the positive electrode active material particles to each other and also to well attach the positive electrode active material to the current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be aluminum foil, nickel foil, or a combination thereof, but is not limited thereto.

The positive electrode active material layer and the negative electrode active material layer are formed by mixing an active material, a binder, and optionally a conductive material in a solvent to prepare an active material composition, and coating this active material composition on a current collector. This method of forming an active material layer is widely known in the art and thus detailed description will be omitted in this specification. The solvent includes N-methyl pyrrolidone and the like, but is not limited thereto. Additionally, if an aqueous binder is used in the negative electrode active material layer, water may be used as a solvent used in preparing the negative electrode active material composition.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methyl propionate, ethyl propionate, propyl propionate, decanolide, mevalonolactone, caprolactone, and the like

The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The non-aqueous organic solvents may be used alone or in combination with one or more. If the organic solvent is used in a mixture, the mixture ratio may be controlled in accordance with a desirable battery performance.

The carbonate-based solvent is prepared by mixing a cyclic carbonate and a chain carbonate. In this case, a mixture of cyclic carbonate and chain carbonate in a volume ratio of 1:1 to 1:9 may result in superior electrolyte solution performance.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

Herein, If the cyclic carbonate and the chain carbonate or the cyclic carbonate and the propionate-based solvent are mixed, they may be mixed in a volume ratio of 1:1 to 1:9 and thus performance of an electrolyte solution may be improved. In addition, if the cyclic carbonate, the chain carbonate, and the propionate-based solvent are mixed, they may be mixed in a volume ratio of 1:1:1 to 3:3:4. The mixing ratios of the solvents may be appropriately adjusted according to desirable properties.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

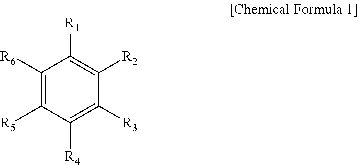

In Chemical Formula 1, R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive of vinylene carbonate, or an ethylene carbonate-based compound of Chemical Formula 2 as a cycle-life enhancing additive.

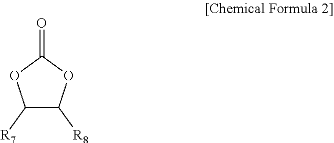

In Chemical Formula 2, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not hydrogen.

Examples of the ethylene carbonate-based compound may include difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. If utilizing more of these cycle-life enhancing additives, the amount utilized may be adjusted appropriately.

The electrolyte may further include vinylethylene carbonate, propane sultone, succinonitrile, or a combination thereof, and the use amount may be adjusted appropriately.

The lithium salt dissolved in an organic solvent supplies a battery with lithium ions, basically operates the lithium secondary battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂) where x and y are natural numbers, for example integers of 1 to 20, lithium difluoro(bisoxalato) phosphate, LiCl, LiI, LiB(C₂O₄)₂ (lithium bis(oxalato) borate: LiBOB), and lithium difluoro(oxalato) borate (LiDFOB), as a supporting electrolytic salt. A concentration of the lithium salt may range from 0.1 M to 2.0 M. If the lithium salt is included at the above concentration range, an electrolyte may have excellent performance and lithium ion mobility due to optimal electrolyte conductivity and viscosity.

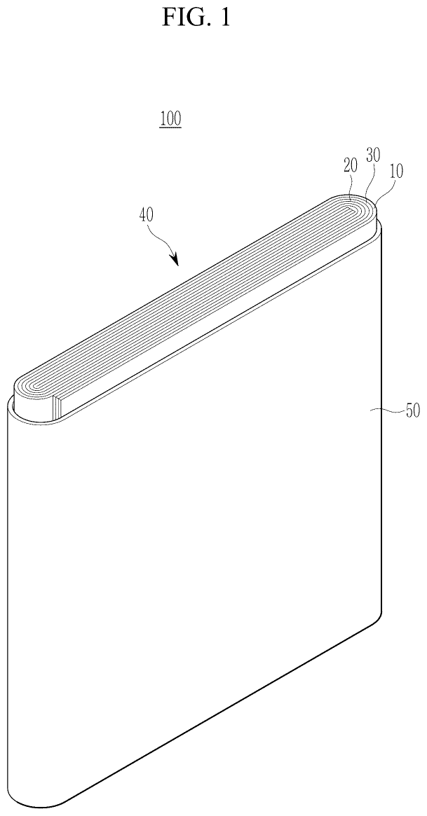

FIG. 1 shows an exploded perspective view of a lithium secondary battery according to an embodiment of the present invention. Although the lithium secondary battery according to an embodiment is described as an example of a prismatic shape, the present invention is not limited thereto and may be applied to batteries of various shapes, such as cylindrical and pouch types.

Referring to FIG. 1, a lithium secondary battery 100 according to an embodiment may include an electrode assembly 40 manufactured by winding a separator 30 disposed between a positive electrode 10 and a negative electrode 20 and a case 50 housing the electrode assembly 40. An electrolyte solution (not shown) may be impregnated in the positive electrode 10, the negative electrode 20 and the separator 30.

### DETAILED DESCRIPTION OF THE EMBODIMENTS

Hereinafter, examples of the present invention and comparative examples are described. These examples, however, are not in any sense to be interpreted as limiting the scope of the invention.

In the following examples and comparative examples, % concentration means wt %.

### Example 1

### 1. Manufacture of Separator

### 1) Formation of Coating Layer

2077.5 g of distilled water and 22.5 g of a poly acrylic acid sodium aqueous solution at a concentration of 40% as a binder were added to 900 g of cubic boehmite with an aspect ratio of 2.0 (available from Anhui Estone Materials Technology Co., Ltd.), and the mixture was milled with a bead mill at 25° C. for 30 minutes to prepare 3000 g of boehmite-binder dispersion with a solid amount of 30 wt %.

10.82 g of the prepared boehmite-binder dispersion, 32.47 g of a polyethylene (PE) particle aqueous solution at a concentration of 40% (a weight average molecular weight of polyethylene particles: 1500 g/mol, an average size (D50) of polyethylene wax: 1 μm, a melting temperature of the polyethylene wax: 113° C.), 0.81 g of a polyglycidyl ether binder aqueous solution) at a concentration of 18.9%, 48.52 g of distilled water, and 7.37 g of a polyacryl amide aqueous solution at a concentration of 8.3% were mixed and then, stirred for 1 hour, preparing a coating liquid.

The coating liquid was die-coated on both sides of a 5.5 μm-thick polyethylene porous substrate (air permeability: 113 sec/100 cc, puncture strength: 280 kgf, a melting temperature: 143° C., SK ie technology Co., Ltd.) and then, dried at 70° C. for 10 minutes to form a coating layer with a thickness of 4 μm (a one surface thickness: 2 μm).

### 2) Formation of Adhesive Layer

On both surfaces of the coating layer, an adhesive layer was formed by mixing an acrylonitrile-styrene-ethylhexyacrylate copolymer binder and a polyvinylidene fluoride filler in a weight ratio of 1:1 to prepar an adhesive solution and then, die-coating the adhesive solution respectively to be 0.5 μm thick and then, drying it at 70° C. for 10 minutes, resultantly manufacturing a separator for a secondary cell.

As a result, the obtained separator had a structure of the porous substrate, the coating layers formed on both surfaces of the porous substrate, and the adhesive layers formed on the surface of the coating layer in contact with the porous substrate and its opposite surface thereof. The manufactured separator had a thickness of 10.5 μm.

### 2. Fabrication of Half-Cell

94 wt % of artificial graphite, 3 wt % of Ketjen black, and 3 wt % of polyvinylidene fluoride were mixed in an N-methyl pyrrolidone solvent to prepare a negative electrode active material layer composition, and the negative electrode active material layer composition was coated on a copper current collector and then, dried and pressurized to manufacture a negative electrode.

The negative electrode, the manufactured separator, and a lithium metal counter electrode were stacked, which was used with an electrolyte to manufacture a half-cell in a common method. The electrolyte was prepared by dissolving 1.5 M LiPF₆ in a mixed solvent of ethylene carbonate, ethylmethyl carbonate, and dimethyl carbonate (in a volume ratio of 2:1:7).

### Example 2

A separator for a lithium secondary cell was manufactured in the same manner as in Example 1 except that the coating liquid was prepared by mixing 5.41 g of the boehmite/binder dispersion of Example 1, 36.53 g of a polyethylene wax aqueous solution at a concentration of 40%, 49.88 g of distilled water, and 7.37 g of a polyacryl amide aqueous solution at a concentration of 8.3%, and the coating liquid was used.

The separator was used in the same manner as in Example 1 to fabricate a half-cell.

### Example 3

A separator for a lithium secondary cell was manufactured in the same manner as in Example 1 except that the coating liquid was prepared by mixing 16.24 g of the boehmite/binder dispersion of Example 1, 28.41 g of a polyethylene wax aqueous solution at a concentration of 40%, 47.17 g of distilled water, and 7.37 g of a polyacryl amide aqueous solution at a concentration of 8.3%, and the coating liquid was used.

The separator was used in the same manner as in Example 1 to fabricate half-cell.

### Example 4

A separator for a lithium secondary cell was manufactured in the same manner as in Example 1 except that the coating liquid was prepared by mixing 21.65 g of the boehmite/binder dispersion of Example 1, 24.35 g of polyethylene wax aqueous solution at a concentration of 40%, 45.82 g of distilled water, and 7.37 g of a polyacryl amide aqueous solution at a concentration of 8.3%, and the coating liquid was used.

The separator was used in the same manner as in Example 1 to fabricate a half-cell.

### Example 5

A separator for a lithium secondary cell was manufactured in the same manner as in Example 1 except that the coating liquid was prepared by mixing 27.06 g of the boehmite/binder dispersion of Example 1, 20.29 g of a polyethylene wax aqueous solution at a concentration of 40%, 44.46 g of distilled water, and 7.37 g of a polyacryl amide aqueous solution at a concentration of 8.3%, and the coating liquid was used.

The separator was used in the same manner as in Example 1 to fabricate a half-cell.

### Example 6

A separator for a lithium secondary cell was manufactured in the same manner as in Example 1 except that the coating liquid was prepared by mixing 32.47 g of the boehmite/binder dispersion of Example 1, 16.24 g of a polyethylene wax aqueous solution at a concentration of 40%, 43.11 g of distilled water, and 7.37 g of a polyacryl amide aqueous solution at a concentration of 8.3%, and the coating liquid was used.

The separator was used in the same manner as in Example 1 to fabricate a half-cell.

### Example 7

A separator for a lithium secondary cell was manufactured in the same manner as in Example 1 except that the coating liquid was prepared by mixing 37.88 g of the boehmite/binder dispersion of Example 1, 12.18 g of a polyethylene wax aqueous solution at a concentration of 40%, 41.76 g of distilled water, and 7.37 g of a polyacryl amide aqueous solution at a concentration of 8.3%, and the coating liquid was used.

The separator was used in the same manner as in Example 1 to fabricate a half-cell.

### Example 8

A separator for a lithium secondary cell was manufactured in the same manner as in Example 1 except that the coating liquid was prepared by mixing 43.29 g of the boehmite/binder dispersion of Example 1, 8.12 g of a polyethylene wax aqueous solution at a concentration of 40%, 40.41 g of distilled water, and 7.37 g of a polyacryl amide aqueous solution at a concentration of 8.3%, and the coating liquid was used.

The separator was used in the same manner as in Example 1 to fabricate a half-cell.

### Example 9

A separator for a lithium secondary cell was manufactured in the same manner as in Example 1 except that the coating liquid was prepared by mixing 48.71 g of the boehmite/binder dispersion of Example 1, 4.06 g of a polyethylene wax aqueous solution at a concentration of 40%, 39.05 g of distilled water, and 7.37 g of a polyacryl amide aqueous solution at a concentration of 8.3%, and the coating liquid was used.

The separator was used in the same manner as in Example 1 to fabricate a half-cell.

### Comparative Example 1

A separator for a lithium secondary cell was manufactured in the same manner as in Example 1 except that the coating liquid was prepared by mixing 0 g of the boehmite/binder dispersion of Example 1, 40.59 g of a polyethylene wax aqueous solution at a concentration of 40%, 51.23 g of distilled water, and 7.37 g of a polyacryl amide aqueous solution at a concentration of 8.3%, and the coating liquid was used.

The separator was used in the same manner as in Example 1 to fabricate a half-cell.

### Comparative Example 2

A separator for a lithium secondary cell was manufactured in the same manner as in Example 1 except that the coating liquid was prepared by mixing 54.12 g of the boehmite/binder dispersion of Example 1, 0 g of a polyethylene wax aqueous solution at a concentration of 40%, 37.70 g of distilled water, and 7.37 g of a polyacryl amide aqueous solution at a concentration of 8.3%, and the coating liquid was used.

The separator was used in the same manner as in Example 1 to fabricate a half-cell.

### Comparative Example 3

A separator for a lithium secondary battery was manufactured in the same manner as in Example 1 except that boehmite with an aspect ratio of 1.3 was used.

The separator was used in the same manner as in Example 1 to manufacture a half-cell.

### Comparative Example 4

A separator for a lithium secondary cell was manufactured in the same manner as in Example 1 except that boehmite with an aspect ratio of 1.4 was used.

The separator was used in the same manner as in Example 1 to fabricate a half-cell.

### Example 10

A separator for a lithium secondary cell was manufactured in the same manner as in Example 1 except that boehmite with an aspect ratio of 1.5 was used.

The separator was used in the same manner as in Example 1 to fabricate a half-cell.

### Example 11

A separator for a lithium secondary cell was manufactured in the same manner as in Example 1 except that boehmite with an aspect ratio of 2.5 was used.

The separator was used in the same manner as in Example 1 to fabricate a half-cell.

### Example 12

A separator for a lithium secondary cell was manufactured in the same manner as in Example 1 except that boehmite with an aspect ratio of 3.0 was used.

The separator was used in the same manner as in Example 1 to fabricate a half-cell.

### Comparative Example 5

A separator for a lithium secondary cell was manufactured in the same manner as in Example 1 except that boehmite with an aspect ratio of 3.1 was used.

The separator was used in the same manner as in Example 1 to fabricate a half-cell.

### Comparative Example 6

A separator for a lithium secondary cell was manufactured in the same manner as in Example 1 except that boehmite with an aspect ratio of 3.2 was used.

The separator was used in the same manner as in Example 1 to fabricate a half-cell.

### Comparative Example 7

A separator for a lithium secondary cell was manufactured in the same manner as in Example 1 except that plate-shaped boehmite with an aspect ratio of 1.5 was used.

The separator was used in the same manner as in Example 1 to fabricate a half-cell.

### Comparative Example 8

A separator for a lithium secondary cell was manufactured in the same manner as in Example 1 except that plate-shaped boehmite with an aspect ratio of 2.0 was used.

The separator was used in the same manner as in Example 1 to fabricate a half-cell.

### Comparative Example 9

A separator for a lithium secondary cell was manufactured in the same manner as in Example 1 except that plate-shaped boehmite with an aspect ratio of 2.5 was used.

The separator was used in the same manner as in Example 1 to fabricate a half-cell.

### Comparative Example 10

A separator for a lithium secondary cell was manufactured in the same manner as in Example 1 except that plate-shaped boehmite with an aspect ratio of 3.0 was used.

The separator was used in the same manner as in Example 1 to fabricate a half-cell.

### Experimental Example 1) Evaluation of Physical Properties

### 1) SEM Measurement

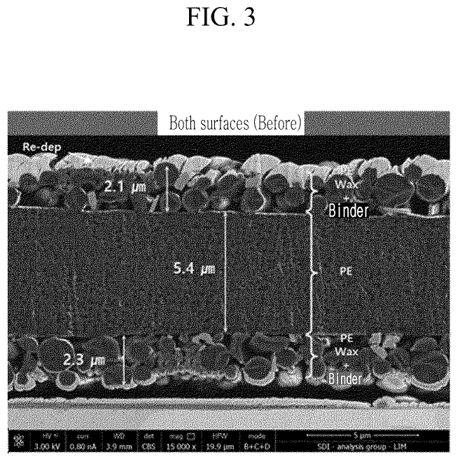

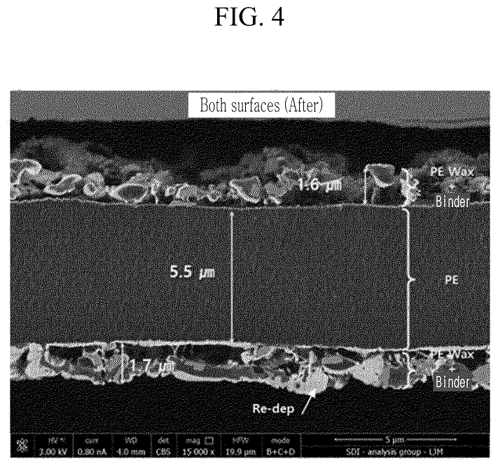

The separator of Example 1 was allowed to stand at 110° C. for 10 minutes. FIG. 3 is SEM images of both surfaces of the separator before being allowed to stand, and FIG. 4 is SEM images of both surfaces of the separator after charging and discharging. As shown in FIG. 3, after being allowed to stand at a high temperature (thermal impact), the polyethylene wax coating layer of the separator was melted. As show in FIGS. 3 and 4, the polyethylene wax of the coating layer at the high temperature was melted and then seeped into the porous polyethylene substrate and thus blocked pores of the porous substrate and made the porous substrate denser, and accordingly, it may be predicted that as a battery temperature increases, battery shutdown may occur to secure battery safety.

### 2) Evaluation of Air Permeability

The separators according to Examples 1 to 12 and Comparative Examples 1 to 10 were allowed to stand at 110° C. for 10 minutes and then, measured with respect to air permeability. The air permeability experiment was performed by using an air permeability meter (TYPE EG01-55-1MR, ASAHI-SEICO Co., Ltd.) to measure time (seconds) that it took for 100 cc of air to pass each separator. As a result, the results of Examples 1 to 9 and Comparative Examples 1 and 2 are shown in Table 1, and the results of Examples 10 to 12 and Comparative Examples 3 to 10 are shown in Table 2. In addition, for comparison, the result of Example 1 is shown in Table 2.

Furthermore, the separator of Example 1, after allowed to stand at a temperature and time as shown in Table 3, was measured with respect to air permeability. The air permeability results are shown in Table 3. The air permeability experiment was performed by using an air permeability meter (TYPE EG01-55-1MR, ASAHI-SEICO Co., Ltd.) to measure time (seconds) that it took for 100 cc of air to pass the separator.

### 3) Evaluation of Binding Force

During the manufacturing process of the separators of Examples 1 to 12 and Comparative Examples 1 to 10, each porous substrate with a coating layer was cut into a width of 12 mm and a length of 50 mm to prepare samples. After attaching a tape adhered to a slide glass to the adhesive layer side of each sample, while the tape and the adhesive layer was peeled off therefrom by using a 180° UTM tensile strength tester to measure a binding force. Herein, a peeling speed was set at 10 mm/min, and the binding force was three times measured to calculate an average value to obtain a force required for peeling 40 mm. As a result, the results of Examples 1 to 9 and Comparative Examples 1 and 2 are shown in Table 1, and the results of Examples 10 to 12 and Comparative Examples 3 to 10 are shown in Table 2. In addition, for comparison, the result of Example 1 is shown in Table 2.

### 4) Evaluation of Shutdown Temperature

The separators of Examples 1 to 12 and Comparative Examples 1 to 10 were measured with respect to a temperature at which shutdown started by increasing the temperature. Among the results, the results of Examples 1 to 9 and Comparative Examples 1 and 2 are shown in Table 1, and the results of Examples 10 to 12 and Comparative Examples 3 to 10 are shown in Table 2. Furthermore, for comparison, the result of Example 1 is shown in Table 2.

In Tables 1 and 2, a fabric panel temperature indicates a shutdown temperature of a polyethylene porous substrate itself.

In Tables 1 and 2, each amount of polyethylene wax and boehmite is provided as a ratio to 100 wt % of a total weight of the polyethylene wax and the boehmite in each coating layer. In addition, a weight and a density mean a weight per area of the coating layer and a density per area of the coating layer.

TABLE 1

| | Example | Comparative | Example | Example | Example | Example | Example | Example | Example | Example | Comparative |
|---|---|---|---|---|---|---|---|---|---|---|---|
| | 1 | Example 1 | 2 | 3 | 4 | 5 | 6 | 7 | 8 | 9 | Example 2 |
| Polyethylene | 80 | 100 | 90 | 70 | 60 | 50 | 40 | 30 | 20 | 10 | 0 |
| wax (wt %) | | | | | | | | | | | |
| Boehmite | 20 | 0 | 10 | 30 | 40 | 50 | 60 | 70 | 80 | 90 | 100 |
| (wt %) | | | | | | | | | | | |
| Aspect ratio | 2.0 | | | | | | | | | | |
| of ceramic | | | | | | | | | | | |
| Ceramic | cubic | cubic | cubic | cubic | cubic | cubic | cubic | cubic | cubic | cubic | cubic |
| shape | | | | | | | | | | | |
| Thickness | 10.5 | 10.5 | 10.5 | 10.5 | 10.5 | 10.5 | 10.5 | 10.5 | 10.5 | 10.5 | 10.5 |
| (μm) | | | | | | | | | | | |
| Air | 204 | 210 | 207 | 200 | 194 | 189 | 182 | 176 | 170 | 164 | 156 |
| permeability | | | | | | | | | | | |
| (sec/100cc) | | | | | | | | | | | |
| Weight | 6.56 | 6.42 | 6.49 | 6.62 | 6.69 | 6.76 | 6.83 | 6.90 | 6.96 | 7.03 | 7.10 |
| (g/m²) | | | | | | | | | | | |
| Density | 0.63 | 0.60 | 0.62 | 0.64 | 0.66 | 0.67 | 0.69 | 0.70 | 0.71 | 0.73 | 0.74 |
| (g/m³) | | | | | | | | | | | |
| Substrate | 3.81 | 3.67 | 3.74 | 3.93 | 4.01 | 4.09 | 4.17 | 4.22 | 4.29 | 4.36 | 4.44 |
| binding | | | | | | | | | | | |
| force(gf/mm) | | | | | | | | | | | |
| Shutdown | 114 | 111 | 112 | 119.5 | 124 | 128.5 | 133 | 137.5 | 142 | 146.5 | 151 |
| temperature | | | | | | | | | | | |
| (° C.) | | | | | | | | | | | |
| [fabric panel | | | | | | | | | | | |
| 146° C.] | | | | | | | | | | | |

TABLE 2

| | Compar- | Compar- | | | | |
|---|---|---|---|---|---|---|
| | ative | ative | | | | |
| | Example 3 | Example 4 | Example 10 | Example 1 | Example 11 | Example 12 |
| Polyethylene | 80 | 80 | 80 | 80 | 80 | 80 |
| wax | | | | | | |
| (wt %) | | | | | | |
| Boehmite | 20 | 20 | 20 | 20 | 20 | 20 |
| (wt %) | | | | | | |
| Aspect | 1.3 | 1.4 | 1.5 | 2.0 | 2.5 | 3.0 |
| ratio | | | | | | |
| of | | | | | | |
| ceramic | | | | | | |
| Ceramic | cubic | | | | | |
| shape | | | | | | |
| Thickness | 10.5 | 10.5 | 10.5 | 10.5 | 10.5 | 10.5 |
| (μm) | | | | | | |
| Air | 230 | 226 | 204 | 204 | 204 | 204 |
| permeability | | | | | | |
| (sec/ | | | | | | |
| 100cc) | | | | | | |
| Weight | 6.90 | 6.70 | 6.56 | 6.56 | 6.56 | 6.56 |
| (g/m²) | | | | | | |
| Density | 0.70 | 0.66 | 0.63 | 0.63 | 0.63 | 0.63 |
| (g/m³) | | | | | | |
| Substrate | 3.32 | 3.51 | 3.81 | 3.81 | 3.81 | 3.81 |
| binding | | | | | | |
| force | | | | | | |
| (gf/mm) | | | | | | |
| Shutdown | 114 | 114 | 114 | 114 | 114 | 114 |
| temperature | | | | | | |
| (° C.) | | | | | | |
| [fabric | | | | | | |
| panel | | | | | | |
| 146° C.] | | | | | | |
| | Compar- | Compar- | Compar- | Compar- | Compar- | Compar- |
| | ative | ative | ative | ative | ative | ative |
| | Example 5 | Example 6 | Example 7 | Example 8 | Example 9 | Example 10 |
| Polyethylene | 80 | 80 | 80 | 80 | 80 | 80 |
| wax | | | | | | |
| (wt %) | | | | | | |
| Boehmite | 20 | 20 | 20 | 20 | 20 | 20 |
| (wt %) | | | | | | |
| Aspect | 3.1 | 3.2 | 1.5 | 2.0 | 2.5 | 3.0 |
| ratio | | | | | | |
| of | | | | | | |
| ceramic | | | | | | |
| Ceramic | cubic | | plate-shaped | | | |
| shape | | | | | | |
| Thickness | 10.5 | 10.5 | 10.5 | 10.5 | 10.5 | 10.5 |
| (μm) | | | | | | |
| Air | 201 | 203 | 245 | 241 | 237 | 235 |
| permeability | | | | | | |
| (sec/ | | | | | | |
| 100cc) | | | | | | |
| Weight | 6.40 | 6.30 | 6.58 | 6.57 | 6.56 | 6.55 |
| (g/m²) | | | | | | |
| Density | 0.58 | 0.56 | 0.64 | 0.63 | 0.63 | 0.62 |
| (g/m³) | | | | | | |
| Substrate | 4.10 | 4.14 | 3.31 | 3.33 | 3.33 | 3.35 |
| binding | | | | | | |
| force | | | | | | |
| (gf/mm) | | | | | | |
| Shutdown | 114 | 114 | 114 | 114 | 114 | 114 |
| temperature | | | | | | |
| (° C.) | | | | | | |
| [fabric | | | | | | |
| panel | | | | | | |
| 146° C.] | | | | | | |

As shown in Tables 1 and 2, Examples 1 to 12, in which cubic ceramic with an aspect ratio of 1.5 to 3 was applied to a coating layer, exhibited short air permeability time and a low shutdown temperature, which confirmed excellent lithium ion movement and excellent stability.

In contrast, Comparative Example 1, in which boehmite was not applied to a coating layer, exhibited long air permeability time, which confirmed that it was difficult for lithium ion movement to properly occur., and Comparative Example 2, in which polyethylene wax was not used, exhibited a very high shutdown temperature.

In addition, Comparative Examples 3 and 4, in which boehmite with a smaller aspect ratio than 1.5 was used, exhibited long air permeability, which confirmed that it was difficult for lithium ion movement to properly occur. Furthermore, Comparatives Example 5 and 6, in which boehmite with a greater aspect ratio than 3.0 was used, exhibited too low coating layer density, which may lead to deteriorating safety. In addition, even though the aspect ratio corresponded to 1.5 to 3.0, the case of using the plate-shaped ceramic exhibited long air permeability, which confirmed that it was difficult for lithium ion movement to properly occur.

TABLE 3

| | | Temperature for allowing to stand | | |
|---|---|---|---|---|
| | | 100° C. | 110° C. | 120° C. |
| Time for | 5 min | 86 sec/100 | 31469 sec/100 | 34012 sec/100 |
| allowing | 10 min | 80 sec/100 | 39211 sec/100 | — |
| to stand | 30 min | 205 sec/100 | — | — |

As shown in Table 3, the separator of Example 1, even though allowed to stand at 110° C. or higher for at least 5 minutes, exhibited too long air permeability, which confirmed that a shutdown effectively occurred at a low temperature. In Table 3, if allowed to stand at 110° C. for 10 minutes and for 30 minutes at 120° C. for 10 minutes and for 30 minutes, the coating layer was melted and thus substantially blocked pores in the porous substrate, which led to failing in measuring the air permeability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims. Therefore, the aforementioned embodiments should be understood to be exemplary but not limiting the present invention in any way.

1. A separator for a lithium secondary battery, the separator comprising:
a porous substrate; and
a coating layer located on at least one surface of the porous substrate and that includes polyethylene particles and ceramics,
wherein the ceramics have an aspect ratio of 1.5 to 3.0.

2. The separator for a lithium secondary battery as claimed in claim 1, wherein the ceramics are cubic.

3. The separator for a lithium secondary battery as claimed in claim 1, wherein the polyethylene particles have a melting temperature (Tm) of 100° C. to 120° C.

4. The separator for a lithium secondary battery as claimed in claim 1, wherein an average molecular weight (Mw) of the polyethylene particles is 1000 g/mol to 5000 g/mol.

5. The separator for a lithium secondary battery as claimed in claim 1, wherein the ceramics comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

6. The separator for a lithium secondary battery as claimed in claim 1, wherein a cross-sectional thickness of the coating layer is 0.5 μm to 5 μm.

7. The separator for a lithium secondary battery as claimed in claim 1, wherein the coating layer further includes a binder.

8. The separator for a lithium secondary battery as claimed in claim 7, wherein the binder comprises one of a dispersion binder, a curable binder, and an aqueous binder.

9. The separator for a lithium secondary battery as claimed in claim 8, wherein the dispersion binder comprises at least one of sodium polyacrylate, ammonium polyacrylate, and potassium polyacrylate.

10. The separator for a lithium secondary battery as claimed in claim 8, wherein the curable binder comprises at least one of polyglycidyl ether, isocyanate, epoxy, an acrylic copolymer, and a fluorine-based binder.

11. The separator for a lithium secondary battery as claimed in claim 8, wherein the aqueous binder comprises at least one of a styrene-butadiene rubber, an acrylated styrene-butadiene rubber, polyvinyl alcohol, a copolymer of propylene and a C2 to C8 olefin, poly acrylamide, and a copolymer of (meth)acrylic acid and (meth)acrylic acid alkyl ester.

12. The separator for a lithium secondary battery as claimed in claim 1, wherein the separator further includes an adhesive layer on one surface of the coating layer.

13. The separator for a lithium secondary battery as claimed in claim 12, wherein the adhesive layer includes a binder and a filler.

14. The separator for a lithium secondary battery as claimed in claim 13, wherein the binder comprises at least one of (meth)acrylic acid, (meth)acrylate, (meth)acrylonitrile, (meth)acrylamidosulfonic acid, a (meth)acrylamidosulfonate salt, styrene, ethylhexyl acrylate, and a copolymer thereof.

15. The separator for a lithium secondary battery as claimed in claim 13, wherein the filler comprises at least one of polyvinylidene fluoride, a polyvinylidene fluoride-hexafluoropropylene copolymer, and polytetrafluoroethylene.

16. The separator for a lithium secondary battery as claimed in claim 13, wherein a mixing ratio of the binder and filler in the adhesive layer is 1:1 to 1:5 by weight.

17. The separator for a lithium secondary battery as claimed in claim 12, wherein a cross-sectional thickness of the adhesive layer is 0.1 μm to 4.0 μm.

18. A lithium secondary battery comprising a negative electrode including a negative electrode active material;
a positive electrode including a positive electrode active material;
the separator as claimed in claim 1 between the negative electrode and the positive electrode; and
a non-aqueous electrolyte.
